(19) United States
(12) Patent Application Publication
(10) Pub. No.: US 2005/0088515 A1
(43) Pub. Date: Apr. 28, 2005

(54) Camera ring for three-dimensional (3D) surface imaging

(76) Inventor: Z. Jason Geng, Rockville, MD (US)

Correspondence Address: STEVEN L. NICHOLS;RADER, FISHMAN & GRAVER PLLC, 10653 S. RIVER FRONT PARKWAY, SUITE 150, SOUTH JORDAN, UT, 84095, US

(21) Appl. No.: 10/973,534

(22) Filed: Oct. 25, 2004

Related U.S. Application Data
(60) Provisional application No. 60/514,518, filed on Oct. 23, 2003.

(51) Int. Cl. H04N 13/02

(52) U.S. Cl. 348/47

(57) ABSTRACT

The present invention provides methods, systems, and apparatuses for three-dimensional (3D) imaging. The present methods, systems, and apparatuses provide 3D surface imaging using a camera ring configuration. According to one of many possible embodiments, a method for acquiring a three-dimensional (3D) surface image of a 3D object is provided. The method includes the steps of: positioning cameras in a circular array surrounding the 3D object; calibrating the cameras in a coordinate system; acquiring two-dimensional (2D) images with the cameras; extracting silhouettes from the 2D images; and constructing a 3D model of the 3D object based on intersections of the silhouettes.

### RELATED APPLICATIONS

This application claims priority under 35 U.S.C.§119(e) to U.S. Provisional Patent Application Ser. No. 60/514,518, filed on Oct. 23, 2003 by Geng, entitled “3D Camera Ring,” the contents of which are hereby incorporated by reference in their entirety.

### FIELD

The present invention provides methods, systems, and apparatuses for three-dimensional (3D) imaging. More specifically, the methods, systems, and apparatuses relate to 3D surface imaging using a camera ring configuration.

### BACKGROUND

Surface imaging of three-dimensional (3D) objects has numerous applications, including integration with internal imaging technologies. For example, advanced diffuse optical tomography (DOT) algorithms require a prior knowledge of the surface boundary geometry of the 3D object being imaged in order to provide accurate forward models of light propagation within the object. Original DOT applications typically used phantoms or tissues that were confined to easily-modeled geometries such as a slab or cylinder. In recent years, several techniques have been developed to model photon propagation through diffuse media having complex boundaries by using finite solutions of the diffusion or transport equation (finite elements or differences) or analytical tangent-plane calculations. To fully exploit the advantages of these sophisticated algorithms, accurate 3D boundary geometry of the 3D object has to be extracted quickly and seamlessly, preferably in real time. However, conventional surface imaging techniques have not been capable of extracting 3D dimensional boundaries with fully automated, accurate, and real-time performance.

Conventional surface imaging techniques suffer from several shortcomings. For example, many traditional surface imaging techniques require that either the sensor (e.g., camera) or the 3D object be moved between successive image acquisitions so that different views of the 3D object can be acquired. In other words, conventional surface imaging techniques are not equipped to acquire images of every view of a 3D object without having the camera or the object moved between successive image acquisitions. This limitation not only introduces inherent latencies between successive images, it can be overly burdensome or even nearly impossible to use for in vivo imaging of an organism that is prone to move undesirably or that does not respond to instructions. Other traditional 3D surface imaging techniques require expensive equipment, including complex cameras and illumination devices. In sum, conventional 3D surface imaging techniques are costly, complicated, and difficult to operate because of their inherent limitations.

### SUMMARY

The present invention provides methods, systems, and apparatuses for three-dimensional (3D) imaging. The present methods, systems, and apparatuses provide 3D surface imaging using a camera ring configuration. According to one of many possible embodiments, a method for acquiring a three-dimensional (3D) surface image of a 3D object is provided. The method includes the steps of: positioning cameras in a circular array surrounding the 3D object; calibrating the cameras in a coordinate system; acquiring two-dimensional (2D) images with the cameras; extracting silhouettes from the 2D images; and constructing a 3D model of the 3D object based on intersections of the silhouettes.

### BRIEF DESCRIPTION OF THE DRAWINGS

The accompanying drawings illustrate various embodiments of the present methods, systems, and apparatuses, and are a part of the specification. Together with the following description, the drawings demonstrate and explain the principles of the present methods, systems, and apparatuses. The illustrated embodiments are examples of the present methods, systems, and apparatuses and do not limit the scope thereof.

FIG. 1 illustrates a camera ring imaging system, according to one embodiment.

FIG. 2 is a flowchart diagram illustrating a method by which the camera ring system of FIG. 1 acquires a 3D model of the surface of the 3D object, according to one embodiment.

FIG. 3A is a view of a calibration image acquired by a first camera sensor, according to one embodiment.

FIG. 3B is another view of the calibration image of FIG. 3A acquired by a second camera sensor, according to one embodiment.

FIG. 4 is a perspective view of a volume cone associated with a silhouette image, according to one embodiment.

FIG. 5A illustrates a number of volume pillars formed in a volume space, according to one embodiment.

FIG. 5B is a geometric representation illustrating a use of pillar to project a line onto an image plane, according to one embodiment.

FIG. 5C is a geometric representation illustrating a process of backwards projecting of line segments from the image plane of FIG. 5B to generate pillar segments, according to one embodiment.

FIG. 6 is a geometric diagram illustrating an Epipolar line projection process, according to one embodiment.

FIG. 7 illustrates an Epipolar matching process, according to one embodiment.

FIG. 8 illustrates a cube having vertices and edges useful for constructing an index to an edge intersection table to identify intersections with a silhouette, according to one embodiment.

FIG. 9 illustrates an example of an isosurface dataset having fifteen different combinations, according to one embodiment.

FIG. 10 is a block diagram illustrating the camera ring system of FIG. 1 implemented in an animal imaging application, according to one embodiment.

FIG. 11A is a perspective view of the camera ring system of FIG. 1 implemented in an apparatus useful for 3D mammography imaging, according to one embodiment.

FIG. 11B is another perspective view of the camera ring system and apparatus of FIG. 10A, according to one embodiment.

FIG. 12 is a perspective view of the camera ring system of FIG. 1 in a 3D head imaging application, according to one embodiment.

FIG. 13 is a perspective view of multiple camera ring systems of FIG. 1 implemented in a full body 3D imaging application, according to one embodiment.

Throughout the drawings, identical reference numbers designate similar, but not necessarily identical, elements.

### DETAILED DESCRIPTION

The present specification describes methods, systems, and apparatuses for three-dimensional (3D) imaging using a camera ring configuration. Using the camera ring configuration, the surface of a 3D object can be acquired with 360 degree complete surface coverage. The camera ring configuration uses multiple two-dimensional (2D) imaging sensors positioned at locations surrounding the 3D object to form a ring configuration. The 2D sensors are able to acquire images of the 3D object from multiple viewing angles. The 2D images are then processed to produce a complete 3D surface image that covers the 3D object from all visible viewing angles corresponding to the 2D cameras. Processes for producing the 3D surface image from the 2D images will be discussed in detail below.

With the camera ring configuration, accurate surface images of complex 3D objects can be generated from 2D images automatically and in real time. Because the 2D images are acquired simultaneously and speedily, there are no inherent latencies introduced into the image data. Complete coverage of the surface of the 3D object can be acquired in a single snap shot without having to move the 3D object or camera between successive images.

The camera ring configuration also reduces imaging costs because low cost 2D sensors can be used. Moreover, the configuration does not require illumination devices and processing. As a result, the camera ring configuration can be implemented at a lower cost than traditional surface imaging devices.

The camera ring configuration also requires fewer post-processing efforts than traditional 3D imaging approaches. While traditional 3D imaging applications require significant amounts of post processing to obtain a 3D surface model, the camera ring configuration and associated algorithms discussed below eliminate or reduce much of the post processing required by traditional 3D imaging applications.

Another benefit provided by the camera ring configuration is its capacity for use with in vivo imaging applications, including the imaging of animals or of the human body. For example, the camera ring configuration provides a powerful tool for enhancing the accuracy of diffuse optical tomography (DOT) reconstruction applications. As will be discussed below, 3D surface data can be coherently integrated with DOT imaging modality. 3D surface imaging systems can be pre-calibrated with DOT sensors, which integration enables easy acquisition of geometric data (e.g., (x, y, z) data) for each measurement point of a DOT image. In particular, the 3D surface data can be registered (e.g., in a pixel-to-pixel fashion) with DOT measurement data to enhance the accuracy of DOT reconstructions. The capacity for enhancing DOT reconstructions makes the camera ring configuration a useful tool for many applications, including but not limited to magnetic resonance imaging (MRI), electrical impedance, and near infrared (NIR) systems. Other beneficial features of the camera ring configuration will be discussed below.

In the following description, for purposes of explanation, numerous specific details are set forth in order to provide a thorough understanding of the present methods, systems, and apparatuses for 3D imaging using the camera ring configuration. It will be apparent, however, to one skilled in the art that the present systems, methods, and apparatuses may be practiced without these specific details. Reference in the specification to “one embodiment” or “an embodiment” means that a particular feature, structure, or characteristic described in connection with the embodiment is included in at least one embodiment. The appearance of the phrase “in one embodiment” in various places in the specification are not necessarily all referring to the same embodiment.

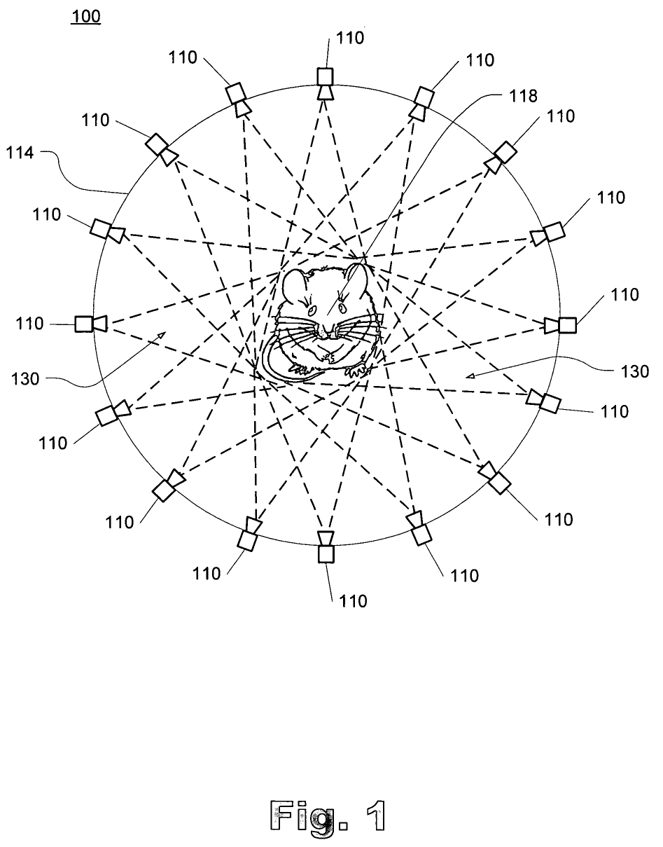

FIG. 1 is a block diagram illustrating a camera ring imaging system (100) (also referred to simply as “the system (100)”) for 3D surface imaging of 3D objects, according to one embodiment. As shown in FIG. 1, a number of cameras (110) are positioned in a circular array (114) surrounding a 3D object or organism (118) to be imaged. Each of the cameras (110) is configured to face inwardly toward the center of the circular array (114), where the 3D object or organism (118) can be placed for imaging. The cameras (110) of FIG. 1 can include any two-dimensional (2D) imagers known to those skilled in the art, including but now limited to web cameras.

Each of the cameras (110) is configured to acquire a picture of a portion of the 3D object (118) that is within a particular image area (130) associated with a particular camera (110). The image areas (130) of the cameras (110) are denoted by dashed lines forming somewhat conical volumes having apexes at the cameras (110). The dashed lines intersect the surface of the 3D object (118) to define, for each camera (110), a 2D image area in between the dashed lines. Using construction algorithms discussed below, the system (100) is capable of assembling multiple 2D images acquired by the cameras (110) to form a comprehensive 360 degree 3D model of the 3D object. In one embodiment of the camera ring configuration, the cameras (110) are equally spaced about the ring (114) to simplify geometric calculations in the construction algorithms.

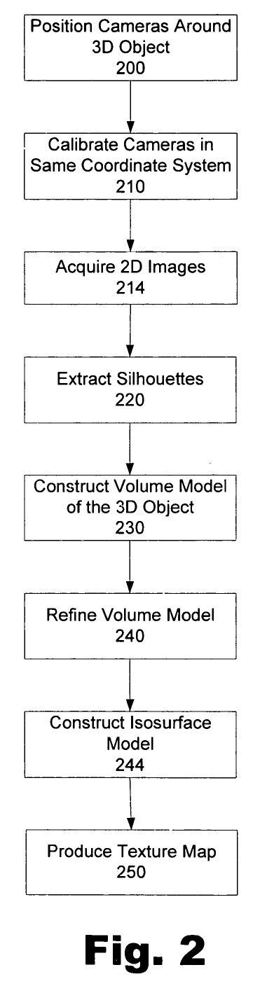

FIG. 2 is a flowchart diagram illustrating a method by which the camera ring system (100) of FIG. 1 acquires a 3D model of the surface of the 3D object (118; FIG. 1), according to one embodiment. At step (200), the cameras (110; FIG. 1) are positioned in a circular array surrounding the 3D object (118; FIG. 1). At step (210), the cameras (110; FIG. 1) are calibrated in the same coordinate system. Calibration within the same coordinate system provides information for determining geometrical relationships between the cameras (110; FIG. 1) and their associated views.

Once the cameras (110; FIG. 1) are calibrated, the cameras (110; FIG. 1) can capture multiple 2D images of different views of the 3D object (118; FIG. 1) at step (214). The 2D images can be acquired simultaneously by the cameras (110; FIG. 1) with a single snapshot. In one embodiment, each of the cameras (10; FIG. 1) acquires one 2D image of the 3D object.

At step 220, silhouettes are extracted from the 2D images acquired by the cameras (110; FIG. 1). Step 220 can be performed using image segmentation techniques, which will be described in detail below.

At step 230, a coarse volume model of the 3D object (118; FIG. 1) is constructed based on intersections of the silhouettes extracted from the 2D images. This construction can be performed using algorithms that identify intersection volume boundaries of volume cones in 3D space. These algorithms will be discussed in detail below.

At step 240, the constructed 3D volume model is refined. Stereoscopic techniques, which will be discussed in detail below, can be used to refine the 3D model by extracting surface profiles using correspondence correlation based on the multiple 2D images acquired from different viewing angles.

At step 244, an isosurface model is constructed using techniques that will be described in detail below. At step 250, a texture map can be produced. The texture map will be representative of the surface of the 3D object (118; FIG. 1). Techniques for generating the texture map will be discussed in detail below.

While FIG. 2 illustrates specific steps for acquiring a 3D model of the surface of a 3D object, not all of the steps are necessary for every embodiment of the invention. For example, step 250 may not be performed in some embodiments. The steps shown in FIG. 2 will now be discussed in more detail.

With respect to calibration of the cameras (110; FIG. 1) at step (210), all of the cameras (110; FIG. 1) should be calibrated in the same coordinate system. Because the cameras (110; FIG. 1) are arranged in circular locations, no planar calibration pattern can be seen by all the cameras (110; FIG. 1). Thus, traditional camera calibration techniques cannot be used here directly to calibrate the cameras (110; FIG. 1) in the ring configuration.

To calibrate the cameras (110; FIG. 1), a pair of adjacent cameras (110; FIG. 1) in the camera ring are used to perform camera calibration by using stereoscopic imaging capabilities. The calibration will then go to the next adjacent pair of cameras (10; FIG. 1) to perform sequential calibrations, thus propagating the geometric coordinate system information to all the cameras (10; FIG. 1) in the camera ring configuration.

To calibrate the cameras (10; FIG. 1), “good features” can be automatically identified, extracted, and used to determine the geometric relationship between cameras (110; FIG. 1). A “good feature” is a textured patch with high intensity variation in both the x and y directions, such as a corner. The intensity function can be denoted by I(x, y), and the local intensity variation matrix can be considered as:

$$Z = [ \begin{matrix}\frac{{\partial }^{2} I}{\partial {x}^{2}} & \frac{{\partial }^{2} I}{\partial x \partial y} \\ \frac{{\partial }^{2} I}{\partial x \partial y} & \frac{{\partial }^{2} I}{\partial {y}^{2}}\end{matrix} ]$$

A patch defined by a 25×25 window is accepted as a candidate feature if in the center of the window, both eigenvalues of Z, λ₁ and λ₁, exceed a predefined threshold λ: min(λ₁,λ₂)>λ.

A Kanade Lucas Tomasi (KLT) feature tracker can be used for tracking good feature points through a video sequence. This tracker can be based on tracking techniques known to those skilled in the art. Good features may be located by examining the minimum eigenvalue of each 2×2 gradient matrix, and features can be tracked using a Newton-Raphson method of minimizing the difference between the two windows, which is known to those skilled in the art.

After having the corresponding feature points of 2D images acquired from two separate cameras (110; FIG. 1), the corresponding points can be used to establish the geometric relationship between 2D images. The geometric relationship can be described by a branch of projective geometry known as Epipolar geometry. Projective geometry is then applied to the results of the Epipolar lines to obtain the intrinsic camera parameters, such as focal length and reference frames of the cameras (110), based on a pinhole model.

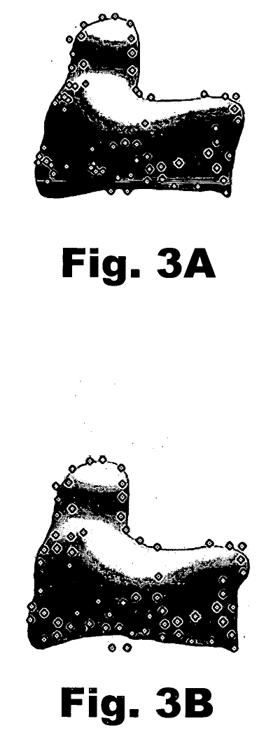

FIGS. 3A and 3B are views of calibration images acquired by different cameras from different viewpoints, according to one embodiment. In FIGS. 3A and 3B, automatically selected feature points are shown as dots on the images.

Corresponding feature points may be aligned to register different images and to determine geometric relationships between the cameras (110; FIG. 1) and points associated with the cameras (110; FIG. 1). The geometric relationships can be used by the system (100; FIG. 1) to construct a 3D model of the 3D object (118; FIG. 1) from different 2D images ofthe 3D object (118; FIG. 1).

With respect to extracting silhouettes from the acquired 2D images at step (220), image segmentation techniques can be used to extract the silhouettes from the 2D images. The purpose of image segmentation is to separate the pixels associated with a target (i.e., the foreground) from background pixels. Usually, thresholding techniques (global or local thresholding) can be applied. In many practical applications, however, dark shadows due to low contrast and poor lighting introduce complications if the background is black. Simple thresholding techniques may not work reliably for dark backgrounds.

In one embodiment, a combination of region growth and connected component analysis techniques are implemented to reliably differentiate between target and background pixels. In the region growth technique, a “seed” pixel is selected (usually from the outmost columns and rows of the image) that exhibits a high probability of lying outside the border of the target (i.e., the silhouette). The intensity of the seed pixel should be less than the global intensity threshold value. A region is grown from this seed pixel until the process cannot proceed further without encountering a target pixel or a boundary of the image. A new seed pixel is then chosen and the process continued until no new seed pixel can be found in the entire image. The process can then be repeated for other 2D images to identify and extract silhouettes.

The connected component technique can be utilized to reduce the noise associated with the result of the region growth process. The largest object in the binary image is found. The rest of the regions in the binary image will be discarded, assuming there is only one target in the image.

In alternative embodiments, known image segmentation techniques are utilized to extract target areas from the 2D images.

Once silhouettes from multiple 2D images are extracted and camera parameters computed, processing moves to construction of the 3D volume model at step (230) of FIG. 2. Each silhouette extends rays of sight from the focal point of the camera (110; FIG. 1) through different contour points of the target silhouette. Volume cones can be used to construct a coarse 3D volume model. Once volume cones from all the 2D images are constructed in the same coordinate system, they are intersected in the 3D world to form the coarse 3D model of the target.

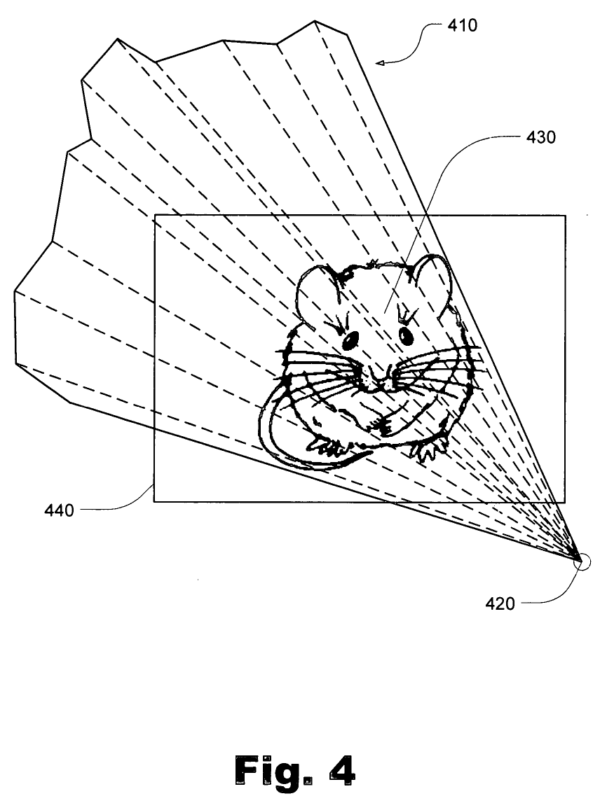

FIG. 4 illustrates volume cone construction techniques, according to one embodiment. As shown in FIG. 4, a volume cone 410 can be formed by projecting rays along lines between the focal point (420) of a particular camera (110; FIG. 1) and points on the edge of the target silhouette (430) of a 2D image (440).

Construction of a 3D surface model is affected by the choice of proper volume representation, which is characterized by low complexity and suitability for a fast computation of volume models. One popular representation, which was first proposed by Meagher, is Octree, which describes the 3D object (118; FIG. 1) hierarchically as a tree of recursively subdivided cubes, down to the finest resolution. In a system disclosed by Hannover, which is well-known in the art, a new volume representation is presented as an alternative to Octrees. In Hannover's system, the volume is subdivided into pillar-like volumes (i.e., pillars) which are built of elementary volume cubes (voxels). These cubes are of the finest resolution. The center points of the cubes at the top and bottom of a pillar describe that pillar's position completely.

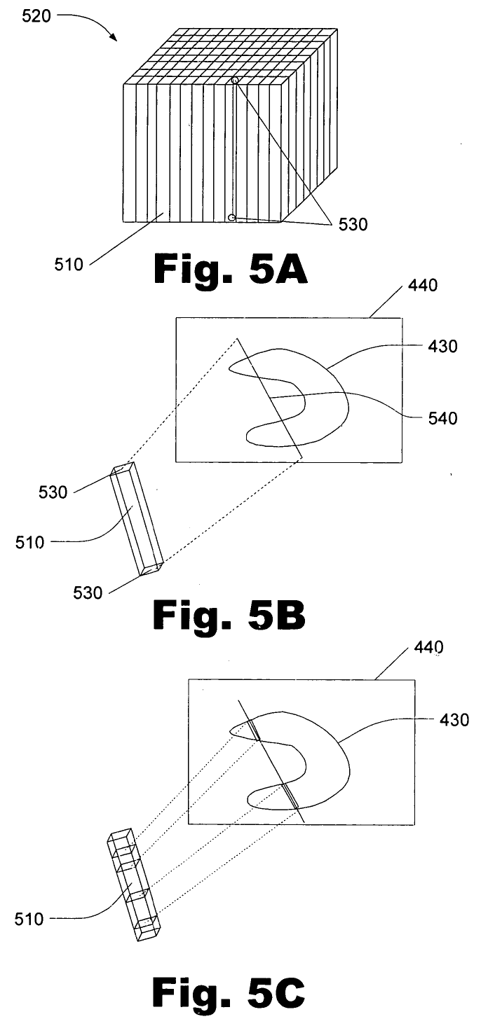

FIGS. 5A-5C illustrate a particular pillar representation process, according to one embodiment. As shown in FIG. 5A, pillars (510) can be used as structures that define a volume (520) of 3D space. Each pillar (510) is defined and described by center points (530) of the cubes (e.g., voxels) at the ends of the pillar (510). The process shown in FIGS. 5A-5C begins with estimating initial volume and forming the pillar elements (510). For each pillar (510) in the volume (520), the center points (530) are projected into the image plane (440) to form a line (540) in the image plane (440). Next, the line (540) is divided into line segments that lie within the target silhouette (430). The end points of each line segment are then projected back onto the 3D pillar (510). The remaining line segments (i.e., the line segments that are not within the target silhouette (430) are eliminated. The volume reconstruction algorithm shown in FIG. 5 is outlined below in Table 1 as pseudo code.

TABLE 1
Pseudo Code for Volume Reconstruction Algorithm

```
Estimate initial volume and form pillar elements;
  For each of the images
    {  For each pillar in the volume
      { Project the pillar's end points into the image plane, which
        form a line in the image;
        Divide the line into segments which lie inside the target
        silhouette; and
        Back-project the end points of each line segment onto 3D
        pillar volume and eliminate the pillar segments that are not
        belong to the silhouette back-projection
      }
    }
```

In comparison with voxel representation, the complexity of using pillars (510) as a volume representation is proportional to the 3D object's (118; FIG. 1) surface area (measured in units of the finest resolution) instead of volume, thus reducing the number of useless voxels that are not used in surface representation.

Once a coarse 3D model has been constructed using the techniques described above, the 3D model can be refined at step (240) of FIG. 2. By combining refining algorithms with coarse construction processes, fundamental limitations of coarse construction processes are overcome. For example, concave shaped 3D objects (118; FIG. 1) are more accurately mapped by using refining algorithms. Further, the combination allows the coarse construction processes to dramatically reduce the search range of the stereoscopic refinement algorithms, as well as improves the speed and quality of the stereoscopic reconstruction. Thus, combining these two complementary approaches will lead to a better 3D model and faster reconstruction processes.

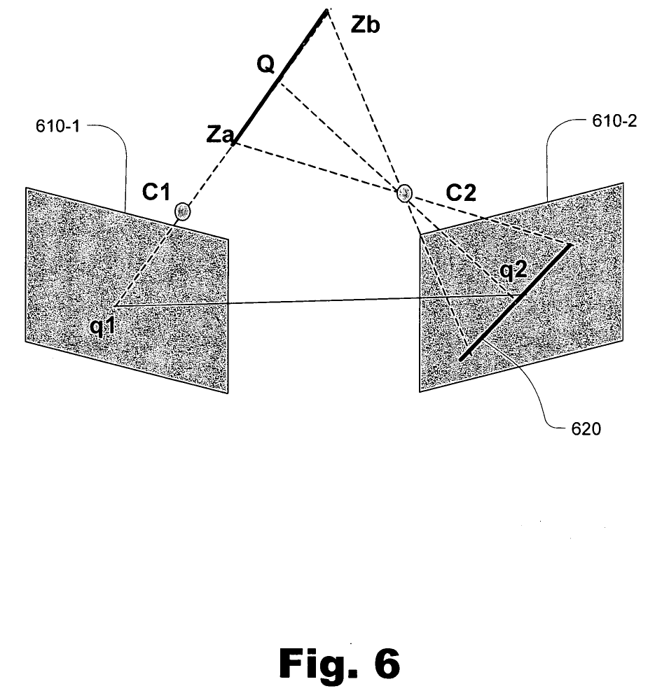

Epipolar line constraints and stereoscopic techniques may be implemented to refine the coarse 3D model. The use of Epipolar constraints reduces the dimension of search from 2D to 1D. Using a pin-hole model of an imaging sensor (e.g., the camera (110; FIG. 1)), the geometric relationship in a stereo imaging system can be established, as shown in FIG. 6, where C1 and C2 are the focal points of Camera 1 and 2. Given any pixel q1 in the 2D image plane (610-1) from camera 1, a line of sight <q1, Q, infinite>can be formed. In practical implementation, it can be assumed that possible Q lies within a reasonable range between Za and Zb . All possible image points of Q long the line segment <Za,Zb>project onto the image plane (610-2) of camera 2, forming an Epipolar line (620). Therefore, search for a possible match of q1 can be performed along a ID line segment. Correspondence match between q1 and q2 provide sufficient information to perform triangulation that computes the (x,y,z) of any point Q in 3D space.

With respect to using stereoscopic techniques, the essence of stereo matching is, given a point in one image, to find corresponding points in another image, such that the paired points on the two images are the projections of the same physical point in 3D space. A criterion can be utilized to measure similarity between images.

The sum of squared difference (SSD) of color and/or intensity values over a window is the simplest and most effective criterion to perform stereo matching. In simple form, the SSD between an image window in Image 1 and an image window of the same size in Image 2 is defined as:

$${C}_{12} ( {x}_{1} , ξ ) = {\sum }_{i ∈ W}^{} \{ {[ {r}_{1} ( {x}_{1} + i ) - {r}_{2} ( ξ + i ) ]}^{2} + {[ {g}_{1} ( {x}_{1} + i ) - {g}_{2} ( ξ + i ) ]}^{2} + {[ {b}_{1} ( {x}_{1} + i ) - {b}_{2} ( ξ + i ) ]}^{2} \}$$

where the sum means summation over a window, x₁ and ξ are the index of central pixel coordinates, and r, g, and b are the values of (r, g, b) representing the pixel color.

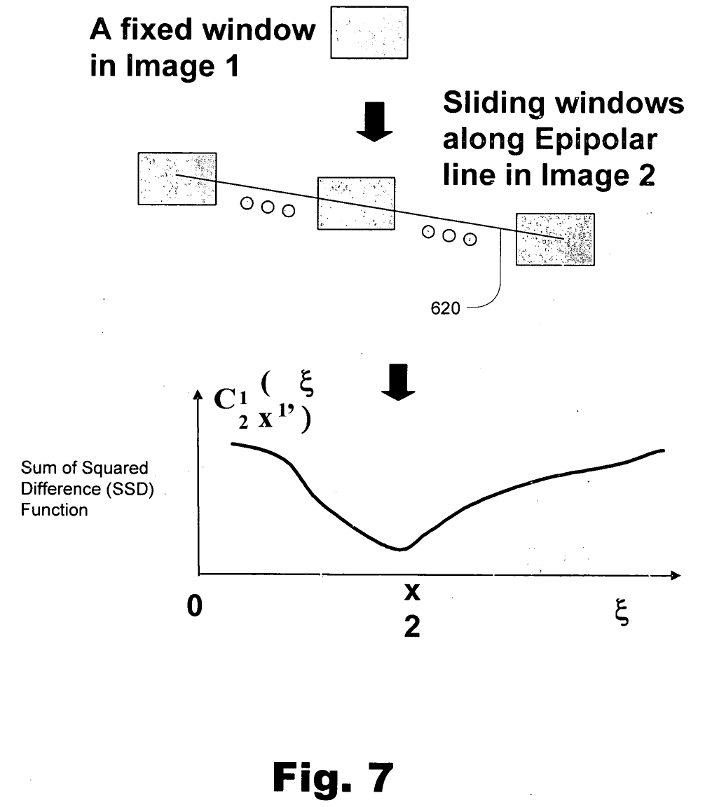

FIG. 7 illustrates an Epipolar match process for use by the system (100), according to one embodiment. To search for a point x2 along the Epilpolar line (620) on Image 2 that match with x1, we select ξ such that it locates along the Epipolar line (620). Based on the location of minimum, x2 can be determined in a straight forward way:

$${x}_{2} = \{ ξ ∈ {C}_{12} ( {x}_{1} , ξ ) \vert {min}_{ξ ∈ Epipolarline} [ {C}_{12} ( {x}_{1} , ξ ) ] \}$$

To improve the quality of the matching, subpixel algorithms can be used and the left-right consistency checked to identify and remove false matches.

Once construction and refinement processes have been completed to create a volumetric model, an isosurface model can be generated at step (244) of FIG. 2. The isosurface model is meant to be understood as a continuous and complete surface coverage of the 3D object (118; FIG. 1). The isosurface model can be generated using the “Marching Cubes” (MC) technique described by W. Lorensen and H. Cline in “Marching Cubes: a high resolution 3D surface construction algorithm ”, ACM Computer Graphics, 21(4):163-170, 1987, the contents of which are hereby incorporated by reference in their entirety. The Marching Cubes technique is a fast, effective, and relatively easy algorithm for extracting an isosurface from a volumetric dataset. The basic concept of the MC technique is to define a voxel (i.e., a cube) by the pixel values at the eight corners of the cube. If one or more pixels of the cube have values less than a user-specified isovalue, and one or more have values greater than this value, it is known that the voxel must contribute some components to the isosurface. By determining which edges of the cube are intersected by the isosurface, triangular patches can be created that divide the cube between regions within the isosurface and regions outside. By connecting the patches from all cubes on the isosurface boundary, a complete surface representation can be obtained.

There are two major components in the MC algorithm. The first is deciding how to define the section or sections of surface which chop up an individual cube. If we classify each corner as either being below or above the defined isovalue, there are 256 possible configurations of corner classifications. Two of these are trivial: where all points are inside or outside the cube does not contribute to the isosurface. For all other configurations, it can be determined where, along each cube edge, the isosurface crosses. These edge intersection points may then be used to create one or more triangular patches for the isosurface.

For the MC algorithm to work properly, certain information should be determined. In particular, it should be determined whether the point at the 3D coordinate (x,y,z) is inside or outside of the object. This basic principle can be expanded to work in three dimensions.

The next step is to deal with cubes that have eight corners and therefore a potential 256 possible combinations of corner status. The complexity of the algorithm can be reduced by taking into account cell combinations that duplicate due to the following conditions: rotation by any degree over any of the 3 primary axes; mirroring the shape across any of 3 primary axes; and inventing the state of all corners and flipping the normals of the relating polygons.

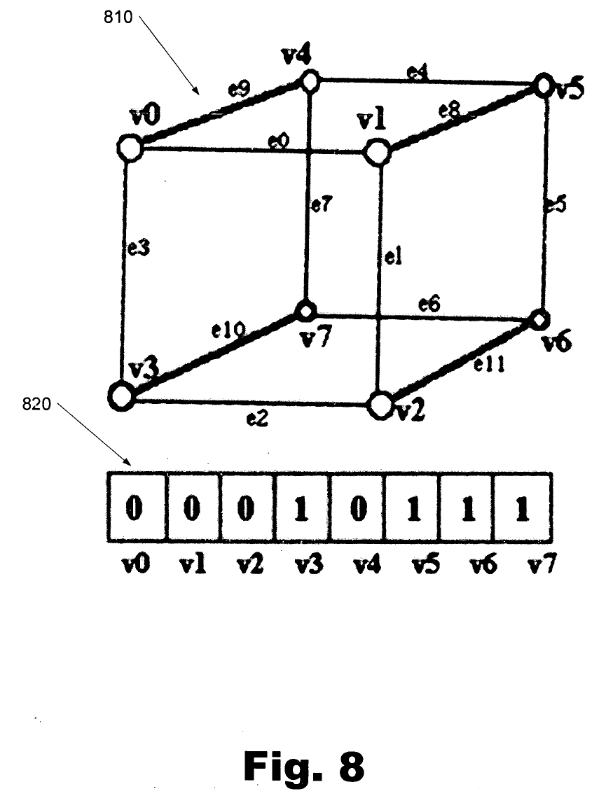

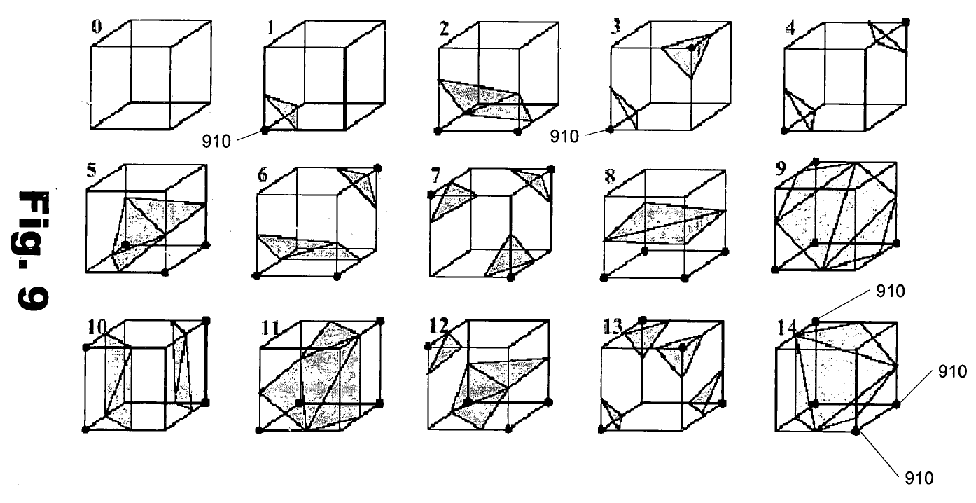

FIG. 8 illustrates a cube (810) having vertices and edges useful for constructing an index (820) to an edge intersection table to identify intersections with a silhouette, according to one embodiment. A table lookup can be used to reduce the 256 possible combinations of edge intersections. The exact edge intersection points are determined and the polygons are created to form the isosurfaces. Taking this into account, the original 256 combinations of cell state are reduced down to a total of 15 combinations, which makes it much easier to create predefined polygon sets for making appropriate surface approximations. FIG. 9 shows an example dataset covering all of the 15 possible combinations, according to one embodiment. The small spheres (910) denote corners that have been determined to be inside the target shape (silhouette).

The Marching Cubes algorithm can be summarized in pseudo code as shown in Table 2.

TABLE 2
Pseudo Code for Marching Cubes Algorithm

```
For each image voxel
    A cube of length 1 is placed on 8 adjacent voxels of the image for
    each of the cube edges
{
    If(the one of the node voxels is above the threshold and the other
below the threshold)
      {Calculate the position of a point on the cube's edge that belongs
    to the isosurface using linear interpolation}
}
For each of the predefined cube configurations {
    For each of the 8 possible rotations {
      For the configuration's complement {
    {Compare the produced pattern of the above calculated iso-points to a
    set of predefined cases and produce the corresponding triangles}
        }
    }
}
```

Each of the non-trivial configurations results in between one and four triangles being added to the isosurface. The actual vertices themselves can be computed by linear interpolation along edges, which will obviously give better shading calculations and smoother surfaces.

Surface patches can now be created for a single voxel or even the entire volume. The volume can be processed in slabs, where each slab is comprised of two slices of pixels. We can either treat each cube independently, or propagate edge intersection between cubes which share the edges. This sharing can also be done between adjacent slabs, which increase storage and complexity a bit, but saves in computation time. The sharing of edge or vertex information also results in a more compact model, and one that is more amenable to interpolating shading.

Once the isosurface has been generated using the processes described above, techniques can be applied to relax the isosurface at step (250) of FIG. 2. The isosurfaces generated with the marching cubes algorithm are not smooth and fair. One of the shortcomings of the known approach is that the triangulated model is likely to be rough, containing bumps and other kinds of undesirable features, such as holes and tunnels, and be non manifold. Therefore, the isosurface can be smoothed based on the approach and filter disclosed by G. Taubin in “A signal processing approach to fair surface design, ” Proceedings of SIGGRAPH 95, pages 351-358, August 1995, the contents of which are hereby incorporated by reference in their entirety. Post-filtering of the mesh after reconstruction using weighted averages of nearest vertex neighbors, which includes smoothing, or fairing, to low-pass filtering, can be performed. This localized filtering preserves the detail in the observed surface reconstruction.

The above-described camera ring system (100; FIG. 1) and related methods for imaging the surface of a 3D object (118; FIG. 1) using the camera ring system 100 have numerous useful applications, several of which will now be described. However, the disclosed systems, methods, and apparatuses are not intended to be limited to the disclosed embodiments.

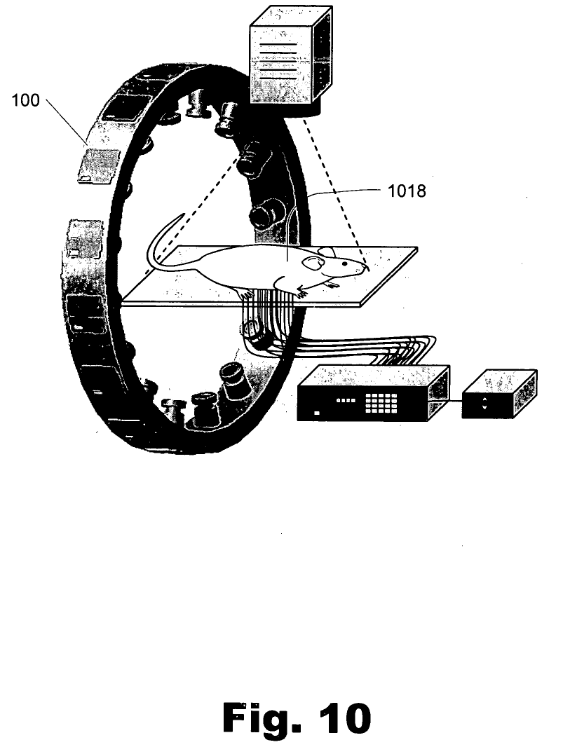

In one embodiment, the camera ring system (100; FIG. 1) and related methods are implemented as a surface profiling system for small animal imaging. FIG. 10 is a block diagram illustrating the camera ring system (100) of FIG. 1 implemented in an animal imaging application, according to one embodiment. In this embodiment, a complete 3D surface profile of a small animal (1018) undergoing in vivo optical tomography imaging procedures can be mapped with a single snap shot. The acquired 3D surface model of the small animal body (1018) provides accurate geometric boundary conditions for 3D reconstruction algorithms to produce precise 3D diffuse optical tomography (DOT) images.

As mentioned above, advanced DOT algorithms require prior knowledge of the boundary geometry of the diffuse medium imaged in order to provide accurate forward models of light propagation within this medium. To fully exploit the advantages of sophisticated DOT algorithms, accurate 3D boundary geometry of the subject should be extracted in practical, real-time, and in vivo manner. Integration of the camera ring system (100) with DOT systems provides capabilities for extracting 3D dimensional boundaries with fully automated, accurate and real-time in vivo performance. This integration facilitates a speedy and convenient imaging configuration for acquiring a 3D surface model with complete 360-degree coverage of animal body surface (1018) without moving a camera or the animal body (1018). This eliminates any previous need to move a DOT image sensor or the animal body (1018) to acquire images from different viewing angles. The 3D camera ring configuration provides this these benefits.

Instead of using single camera and a motion stage to acquire multiple images of the animal body surface (1018), multiple fixed cameras (110; FIG. 1) are placed around the animal body (1018) as shown in FIG. 10. In this configuration, the cameras are able to simultaneously acquire multiple surface images in vivo (FIG. 1). Distinguished advantages of this proposed imaging method include: complete 360° coverage of the animal body surface (1018) in single snap shot; high speed acquisition of multiple latency-free images of the animal (1018) from different viewing angles in a fraction of a second; capabilities for integration with in vivo imaging applications; minimal post processing to obtain a complete and seamless 3D surface model within a few seconds; coherent integration of 3D surface data with DOT imaging modality; and potential low-cost and high performance surface imaging systems that do not require use of expensive sensors or illumination devices.

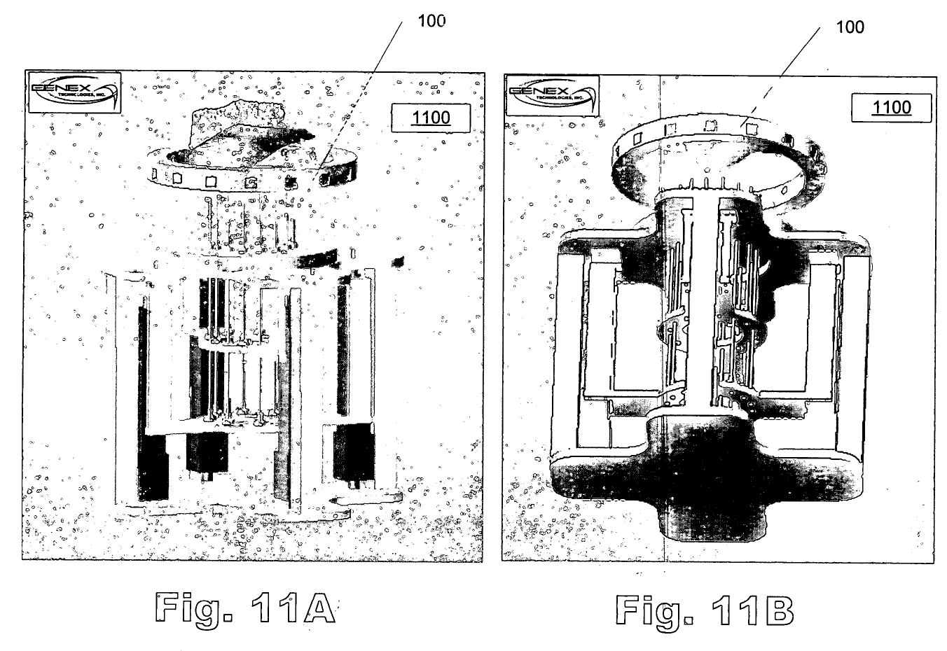

A second embodiment of the camera ring system (100; FIG. 1) includes integration of the system (100; FIG. 1) with microwave, impedance, and near infrared imaging devices. For example, FIGS. 11A and 11B are perspective views of the camera ring system (100) of FIG. 1 implemented in an apparatus (1100) useful for 3D mammography imaging, according to one embodiment. By integrating the camera ring system (100) with MRI, electrical impedance, or near infrared (NIR) imaging systems, precise 3D surface images can be used as patient-specific geometric boundary conditions to enhance the accuracy of image reconstruction for the MRI, electrical impedance, and (NIR) imaging systems.

Existing designs of MRI, electrical impedance, and NIR imaging devices do not have sufficient space under a breast to host traditional off-the-shelf 3D surface cameras for in-vivo image acquisition. Instead of using traditional single pair sensor-projector configurations, the camera ring system (100) and it advanced 3D imaging processing algorithms described above are able to derive an accurate 3D surface profile of the breast based on the multiple 2D images acquired by the cameras (110; FIG. 1) from different viewing angles. In addition to the advantage of being able to acquire a full 360-degree surface profile of a suspended breast, the thin layer design configuration of the camera ring system (100) lends itself well to integration into Microwave, impedance, NIR, and other known imaging systems.

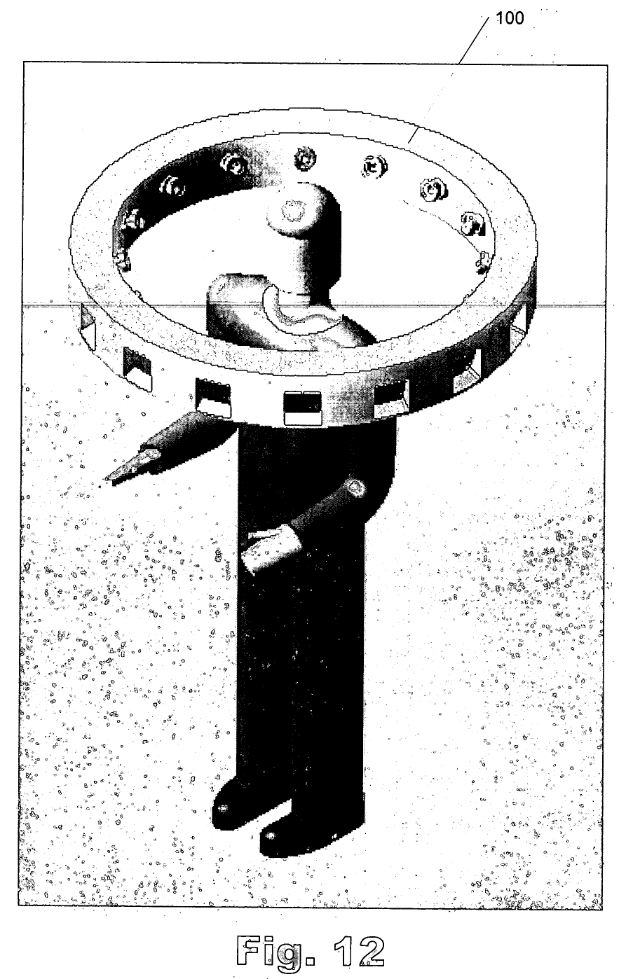

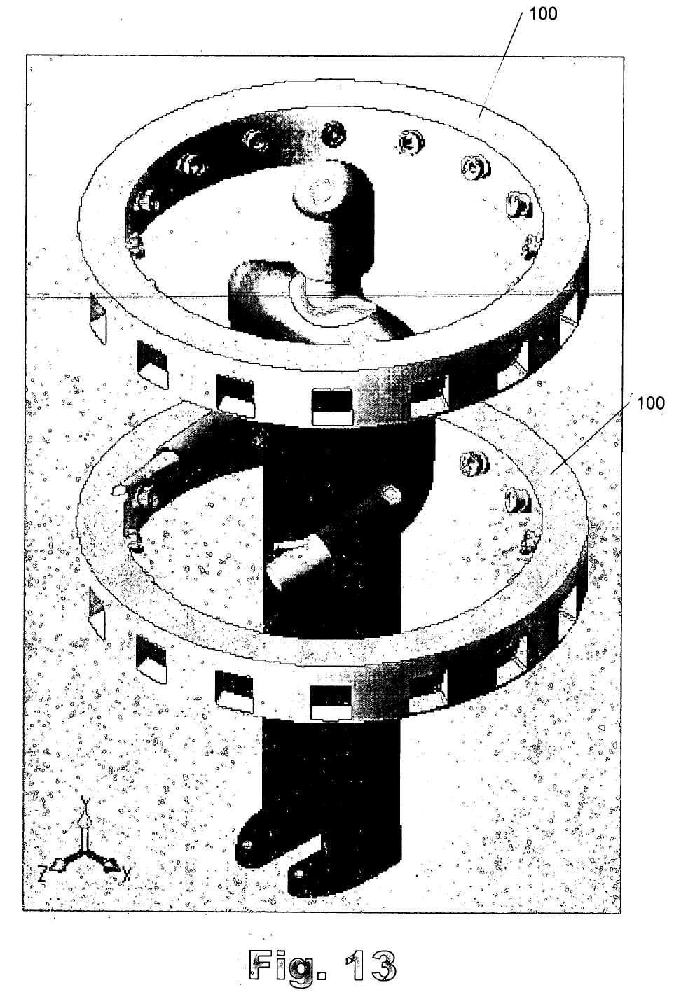

The camera ring system (100) can be configured to map many various types and forms of object surfaces. For example, FIG. 12 is a perspective view of the camera ring system (100) of FIG. 1 in a 3D human head imaging application, according to one embodiment. FIG. 13 is a perspective view of another embodiment that utilizes multiple camera rings systems (100) for a full body 3D imaging application.

The functionalities and processes of the camera ring system (100; FIG. 1) can be embodied or otherwise carried on a medium or carrier that can be read and executed by a processor or computer. The functions and processes described above can be implemented in the form of instructions defined as software processes that direct the processor to perform the functions and processes described above.

In conclusion, the present methods, systems, and apparatuses provide for generating accurate 3D imaging models of 3D object surfaces. The camera ring configuration enables the capture of object surface data from multiple angles to provide a 360 degree representation of the object's surface data with a single snap shot. This process is automatic and does not require user intervention (e.g., moving the object or camera). The ring configuration allows the use of advanced algorithms for processing multiple 2D images of the object to generate a 3D model of the object's surface. The systems and methods can be integrated with known types of imaging devices to enhance their performance.

The preceding description has been presented only to illustrate and describe the present methods and systems. It is not intended to be exhaustive or to limit the present methods and systems to any precise form disclosed. Many modifications and variations are possible in light of the above teaching.

The foregoing embodiments were chosen and described in order to illustrate principles of the methods and systems as well as some practical applications. The preceding description enables those skilled in the art to utilize the methods and systems in various embodiments and with various modifications as are suited to the particular use contemplated. It is intended that the scope of the methods and systems be defined by the following claims.

1. A method for acquiring a three-dimensional (3D) surface image of a 3D object, the method comprising:
positioning a plurality of cameras in a circular array surrounding the 3D object;
calibrating said plurality of cameras in a coordinate system;
acquiring a plurality of two-dimensional (2D) images with said plurality of cameras;
extracting a plurality silhouettes from said plurality of 2D images; and
constructing a 3D model of the 3D object based on intersections of said silhouettes.

2. The method of claim 1, further comprising refining said 3D model using a stereoscopic technique.

3. The method of claim 2, wherein said step of refining includes combining silhouette modeling and stereoscopic modeling algorithms to produce an improved 3D model.

4. The method of claim 2, wherein said step of refining includes utilizing Epipolar line constraints to reduce processing demands associated with said stereoscopic technique.

5. The method of claim 1, wherein said step of constructing includes choosing a volume representation of the 3D object.

6. The method of claim 5, wherein said step of choosing includes implementing a pillar-like volume representation of a cube.

7. The method of claim 1, wherein said step of constructing includes generating volume cones associated with each of said plurality of 2D images and intersecting said volume cones in the coordinate system to form said 3D model.

8. The method of claim 1, wherein said step of calibrating includes sequentially utilizing stereoscopic imaging capability of adjacent pairs of said plurality of cameras to map each of said plurality of cameras to the coordinate system.

9. The method of claim 1, wherein said step of calibrating includes determining a geometric relationship between corresponding points of said plurality of 2D images.

10. The method of claim 1, wherein said step of acquiring includes capturing said plurality of 2D images simultaneously.

11. The method of claim 1, wherein said step of extracting includes identifying pixels outside of said plurality of silhouettes by using a region growth technique.

12. The method of claim 1, wherein said step of extracting includes utilizing a connected component technique to reduce image noise.

13. The method of claim 1, further comprising constructing an isosurface model of the surface of the 3D object.

14. The method of claim 13, wherein said step of constructing said isosurface model includes utilizing a Marching Cubes technique to identify intersections of voxels with said plurality of silhouettes.

15. The method of claim 14, wherein said step of constructing said isosurface model includes producing triangles representative of sections of said isosurface by matching said intersections to a set of predefined intersection patterns.

16. The method of claim 13, further comprising relaxing said isosurface by utilizing smoothing and fairing techniques.

17. The method of claim 1, further comprising generating a texture map of the 3D object with a 3D reconstruction algorithm.

18. The method of claim 1, wherein said step of positioning includes equally spacing said plurality of cameras about said circular array.

19. A camera ring system for acquiring a three-dimensional (3D) surface image of a 3D object, the system comprising:
a plurality of cameras positioned in a circular array surrounding the 3D object;
a processor communicatively coupled to said plurality of cameras and configured to execute instructions, said instructions being configured to direct said processor to perform the steps of:
calibrating said plurality of cameras in a coordinate system;
acquiring a plurality of two-dimensional (2D) images with said plurality of cameras;
extracting a plurality silhouettes from said plurality of 2D images; and
constructing a 3D model of the 3D object based on intersections of said silhouettes.

20. The system of claim 19, wherein said instructions are further configured to direct said processor to perform a step of refining said 3D model using a stereoscopic technique.

21. The system of claim 20, wherein said step of refining includes combining silhouette modeling and stereoscopic modeling algorithms to produce an improved 3D model.

22. The system of claim 20, wherein said step of refining includes utilizing Epipolar line constraints to reduce processing demands associated with said stereoscopic technique.

23. The system of claim 19, wherein said step of constructing includes choosing a volume representation of the 3D object.

24. The system of claim 23, wherein said step of choosing includes implementing a pillar-like volume representation of a cube.

25. The system of claim 19, wherein said step of constructing includes generating volume cones associated with each of said plurality of 2D images and intersecting said volume cones in the coordinate system to form said 3D model.

26. The system of claim 19, wherein said step of calibrating includes sequentially utilizing stereoscopic imaging capability of adjacent pairs of said plurality of cameras to map each of said plurality of cameras to the coordinate system.

27. The system of claim 19, wherein said step of calibrating includes determining a geometric relationship between corresponding points of said plurality of 2D images.

28. The system of claim 19, wherein said step of acquiring includes capturing said plurality of 2D images simultaneously.

29. The system of claim 19, wherein said step of extracting includes identifying pixels outside of said plurality of silhouettes by using a region growth technique.

30. The system of claim 19, wherein said step of extracting includes utilizing a connected component technique to reduce image noise.

31. The system of claim 19, wherein said instructions are further configured to direct said processor to perform a step of constructing an isosurface model of the surface of the 3D object.

32. The system of claim 31, wherein said step of constructing said isosurface model includes utilizing a Marching Cubes technique to identify intersections of voxels with said plurality of silhouettes.

33. The system of claim 32, wherein said step of constructing said isosurface model includes producing triangles representative of sections of said isosurface by matching said intersections to a set of predefined intersection patterns.

34. The system of claim 31, wherein said instructions are further configured to direct said processor to perform a step of relaxing said isosurface by utilizing smoothing and fairing techniques.

35. The system of claim 19, wherein said instructions are further configured to direct said processor to perform a step of generating a texture map of the 3D object with a 3D reconstruction algorithm.

36. The system of claim 19, wherein said step of positioning includes equally spacing said plurality of cameras about said circular array.

37. An apparatus, comprising:
a plurality of cameras positioned about a circular array configured to surround a three-dimensional (3D) object, said cameras being configured to simultaneously capture a plurality of two-dimensional (2D) images from different viewpoints relative to the 3D object.

38. The apparatus of claim 37, wherein said plurality of cameras are spaced equally apart about said circular array.

39. The apparatus of claim 37, wherein said plurality of cameras are positioned to provide complete 360 degree surface coverage of the 3D object.

40. The apparatus of claim 37, wherein said plurality of cameras are positioned within a common plane.
